(19) United States
(12) Patent Application Publication
(10) Pub. No.: US 2010/0136497 A1
(43) Pub. Date: Jun. 3, 2010

(54) ADJUSTABLE SPACE RETAINER AND REGAINER

(76) Inventor: Enis Yasar Guray, Ankara (TR)

Correspondence Address: VENABLE, CAMPILLO, LOGAN & MEANEY, P.C., 1938 E. OSBORN RD, PHOENIX, AZ, 85016-7234, US

(21) Appl. No.: 12/444,532

(22) PCT Filed: Oct. 8, 2007
(86) PCT No.: PCT/IB07/02990

§ 371 Date: Feb. 10, 2010

(30) Foreign Application Priority Data
Oct. 6, 2006 (TR) 2006/05560
Oct. 5, 2007 (TR) 2007/06889

(51) Int. Cl. A61C 7/10

(52) U.S. Cl. 433/7

(57) ABSTRACT

This invention is related to easily maintain the mesio-distal dimension of the lost deciduous tooth and at the same time providing the appliance to be adjusted to any posterior space even at the first visit. If necessary it can also re-gain the lost space. The apparatus can be manufactured of Cr-Ni, titanium or similar metals. The appliances has two bondable surfaces to bond the appliance to the buccal surfaces of the teeth adjacent to the extraction space, the anterior and posterior vertical connecting arms extending from these surfaces to the vestibular side of the teeth, adjusted to the dental and gingival contours. The posterior tubular arm conforming to its name possesses two. The thinner one which is soldered at the bottom of the front side is called the “guide tube” and it has wider internal diameter than the other tube. While gaining space, it guides the “anterior piston arm” directly to the second tube of the “posterior tubular arm”, when these two arms are angulated due to the bended adjacent teeth.

### TECHNICAL FIELD

This invention is related to an orthodontic space retainer appliance used to maintain and regain the space due to the lost of the posterior deciduous teeth, in order to prevent crowding during permanent dentition and more specifically it is related to a fixed adjustable space retainer apparatus.

As the deciduous teeth are lost untimely, the neighboring teeth move to the space left behind. Especially losing the posterior deciduous teeth may cause severe crowding during permanent dentition.

### BACKGROUND ART

Space retainers are used to maintain the spaces of the lost teeth. Fixed or removable retainer apparatus have been used since the beginning of the 20th century in the fields of orthodontics and pediatric dentistry.

Whether fixed or removable, there are certain prerequisites for all space maintainers:

1. They should maintain the mesio-distal dimension of the lost tooth.

2. They should be as simple and strong as possible.

3. They must be easily cleaned and not serve as traps for debris which might enhance dental caries and soft tissue pathology.

4. Their construction must not prevent or restrict normal growth and developmental processes or interfere with such functions as mastication, speech or deglutition.

Of these several space retainer apparatus, a removable space retainer known as Hawley Plate requires a good patient co-operation besides it has application difficulties. They can be easily lost by the patient and they tend to break easily. It is difficult for the patient to adapt to the apparatus in the beginning and when not cleaned properly on a regular basis, it causes deterioration of the oral hygiene. They are difficult to manufacture and expensive. Besides, these appliances have negative effects on speech and deglutition functions.

On the other hand, the fixed type space retainer apparatus are commonly fixed to the molar bands and different diameters of wires are welded to these bands. They maintain the space by leaning against the adjacent tooth of the extraction sites.

Their construction and application is relatively more difficult and more expensive than removable apparatuses. There are several space retainers in the state of the art. The fixed retainer developed by Dr. Graber is the most known and mostly preferred one.

The disadvantages of this apparatus are the same as described above for fixed and removable maintainers namely relatively long chair time is required comparing to the present space retainer. They require obtaining an impression followed by a laboratory work.

However for their more frequent usage by the dentists, all kind of maintainers should fabricate more simply and they should also easily place to the maintained area.

Another space retainer developed for this reason is the “New Universal Space Maintainer” published by Dr. Atanasios Athanasiou and Dr. Nicolas Farsalis at August 1984 Th issue of the Journal of Clinical Orthodontics. In spite they have both common function as retainer however it can not regain any space. Furthermore it necessitates additional adaptation and fixation out of the mouth. However he retainer on this application can be directly applied without any pre-adaptation or stabilization. This peculiarity and its ability to regain the space differs the Adjustable Space Retainer and Regainer of this application from the above mentioned retainer.

In order to overcome these advantages, a retainer as shown in the attached drawings and described here below has been developed. This apparatus can be easily applied to any mesio-distal dimension of the lost tooth. With this appliance the extraction space can be easily and practically maintain or regain.

### DISCLOSURE OF THE INVENTION

The object of this invention is to easily maintain the mesio-distal dimension of the lost deciduous tooth and at the same time providing the appliance to be adjusted to any posterior space even at the first visit. If necessary it can also re-gain the lost space.

This retainer can be preferred for preventive orthodontic and pedodontic treatments.

FIG. 1 is the general view of the retainer appliance.

The parts of the retainer are numerated in the figure and described below:

1. Two concave and fixed bonding surfaces to connect the retainer to the adjacent teeth.

2. Vertical arms lying from bonding surfaces to the posterior tubular arm and to the anterior piston arm.

3. Posterior tubular arm, lying from posterior to anterior which contains two holes welded in its bottom. Anterior tube is called the guide tube.

4. Anterior piston arm, lying from anterior to the posterior.

5. Stopper to stabilize the length of the appliance. It is also used as a stopper for the coil spring.

6. The guide tube larger in inner diameter than the posterior tube, is served to guide the anterior piston arm to the posterior tube, while regaining space in the cases with tipped adjacent teeth.

7. The posterior tube served to adjust the length of the appliance by sliding the anterior piston arm in between.

8. Coil spring is served to create force for regaining space by activating it between the stopper and the guide tube.

The appliance according to this invention can be manufactured of Cr-Ni, titanium or similar metal.

The appliances has two bondable surfaces (FIG. 1, no; 1) to bond the appliance to the buccal surfaces of the teeth adjacent to the extraction space, the anterior and posterior vertical connecting arms extending from these surfaces to the vestibular side of the teeth, adjusted to the dental and gingival contours (FIG. 1, no; 2). The posterior tubular arm conforming to its name possesses two tubes (FIG. 1, no; 3). The thinner one which is soldered at the bottom of the front side is called the “guide tube” (FIG. 1, no; 6) and it has wider internal diameter than the other tube. While gaining space, it guides the “anterior piston arm” directly to the second tube (FIG. 1, no; 7) of the “posterior tubular arm” (FIG. 1, n; 4), when these two arms are angulated due to the bended adjacent teeth. The second tube is wider in anterior-posterior dimension provides to adjust the length of the retainer (FIG. 1, no; 7). The “anterior piston arm” (FIG. 1, no; 4) is entering toward the inside of the two tubes to adjust the mesio-distal width of the appliance. The whole system is fixed by simply squeezing the stopper (FIG. 1, no; 5) with a simple pliers after propping it to the “guide tube”. For gaining space a coil spring (FIG. 2, no; 8) is applied between the stopper and the guide tube. In this cases the activation length of the coil spring is adjusted again by squeezing the stopper (FIG. 2, no; 5) with a pliers.

### BRIEF DESCRIPTION OF THE DRAWINGS

FIG. 1 is the general view of the retainer appliance.

The parts of the retainer are numerated in the figure and described below:

1. Two concave and fixed bonding surfaces to connect the retainer to the adjacent teeth.

2. Vertical arms lying from bonding surfaces to the posterior tubular arm and to the anterior piston arm.

3. Posterior tubular arm, lying from posterior to anterior which contains two holes welded in its bottom. Anterior tube is called the guide tube.

4. Anterior piston arm, lying from anterior to the posterior.

5. Stopper to stabilize the length of the appliance. It is also used as a stopper for the coil spring.

6. The guide tube larger in inner diameter than the posterior tube, is served to guide the anterior piston arm to the posterior tube, while regaining space in the cases with tipped adjacent teeth.

7. The posterior tube served to adjust the length of the appliance by sliding the anterior piston arm in between.

8. Coil spring is served to create force for regaining space by activating it between the stopper and the guide tube.

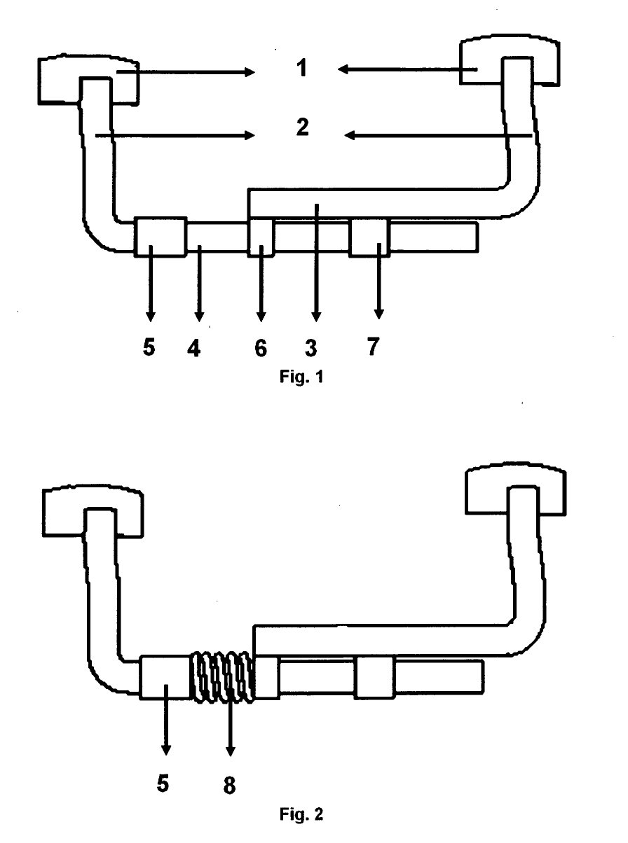

1. The fixed and easy apparatus aims to maintain the mesio-distal dimension of the lost deciduous tooth by bonding to the vestibular surfaces of the adjacent teeth, has two bondable surfaces which can be easily adapted to any mesio-distal dimension of the lost tooth (FIG. 1, no; 1), two anterior and posterior vertical connecting arms, adjusted to the dental and gingival contours, extending from these surfaces (FIG. 1, no; 2), the posterior tubular arm with two tubes (FIG. 1, no; 3), the thinner “guide tube” (FIG. 1, no; 6) and the wider posterior tube (FIG. 1, no; 7), the “anterior piston arm” (FIG. 1, no; 4) which is entering toward the inside of the two tubes to adjust the mesio-distal width of the appliance, the stopper (FIG. 1, no; 5) fixing the whole appliance by squeezing with a simple pliers, and for gaining space a coil spring (FIG. 2, no; 8) applied between the stopper and the guide tube and its activation length adjusted again by squeezing the stopper (FIG. 2, no; 5) with a pliers.

2. The apparatus according to claim 1 wherein the piston arm (FIG. 1, no; 4) is slidably adjusted within the tubes (FIG. 1, no; 6 & 7) in order to adjust to the mesio-distal dimension of the lost teeth.

3. The apparatus according to claim 1 wherein the connection is realized by squeezing the stopper (FIG. 1, no; 5) by means of any pliers.

4. The apparatus according to claim 1 wherein the activation and regaining of space is provided by the application of a coil spring (FIG. 2, no; 8) between the stopper and the guide tube.

5. The apparatus according to claim 1 wherein the guide tube (FIG. 1, no; 6) has wider internal diameter for guiding the “anterior piston arm” directly to the second tube (FIG. 1, no; 7) of the “posterior tubular arm”, when these two arms are angulated due to the bended adjacent teeth.
